(19) United States
(12) Patent Application Publication
(10) Pub. No.: US 2016/0123467 A1
(43) Pub. Date: May 5, 2016

(54) GASKET FOR AUTOMOBILE FUEL TANK

(71) Applicants: Nichias Corporation, Chuo-ku (JP); Toyota Jidosha Kabushiki Kaisha, Toyota-shi (JP)

(72) Inventors: Yutaka TERANISHI, Chuo-ku (JP); Kentaro KIMURA, Chuo-ku (JP); Masahide KOBAYASHI, Toyota-shi (JP); Shinji SHIMOKAWA, Seto-shi (JP)

(73) Assignees: Nichias Corporation, Chuo-Ku (JP); Toyota Jidosha Kabushiki Kaisha, Toyota-shi (JP)

(21) Appl. No.: 14/860,927

(22) Filed: Sep. 22, 2015

(30) Foreign Application Priority Data
Nov. 4, 2014 (JP) 2014-224628

(51) Int. Cl. F16J 15/10; F16J 15/02; F16L 23/22

(52) U.S. Cl. CPC F16J 15/104; F16L 23/22; F16J 15/022

(57) ABSTRACT

Provided is a gasket for an automobile fuel tank that is attached to a connection part in which a fuel supply pipe is connected to an automobile fuel tank and can suppress permeation of gasoline more effectively.

Along an inner periphery or an outer periphery of an O-ring 2 made of nitrile-butadiene rubber, a cross-sectionally rectangular annular member 3 made of polytetrafluoroethylene is arranged in close contact with the O-ring 2, and the O-ring 2 is protruded in thickness direction relative to the upper and lower surfaces in the thickness direction of the annual member 3 by allowing a thickness of the O-ring 2 to be larger than the thickness of the annular member 3.

### TECHNICAL FIELD

The present invention relates to a gasket for an automobile fuel tank that can suppress permeation of gasoline from an automobile fuel tank more effectively.

### BACKGROUND ART

In recent years, demand for reducing automobile fuel consumption has increased than ever, and various attempts are being made in order to solve this problem.

An improvement in efficiency of an internal combustion engine greatly contributes to reduce automobile fuel consumption. However, permeation of gasoline from a fuel tank cannot be neglected. That is, a pipe for fuel supply is connected to an automobile fuel tank, and leakage to the outside by permeation of part of gasoline vaporized in a fuel tank through the gasket itself attached to a connection part in which the pipe is connected to the tank has heretofore been regarded as a problem to be solved.

If it is possible to prevent such permeation of gasoline from a fuel tank more effectively, such effective prevention is expected to greatly contribute to reduce automobile fuel consumption. For example, in Patent Documents 1 and 2, a gasket capable of suppressing permeation of gasoline vaporized in a fuel tank was proposed.

### RELATED ART DOCUMENTS

### Patent Documents

Patent Document 1: JP-A-2001-280509

Patent Document 2: JP-A-2003-201929

### SUMMARY OF INVENTION

### Problem to be Solved by the Invention

However, the gasket proposed in Patent Documents 1 and 2 have room for further improvements in suppressing permeation of gasoline vaporized in a fuel tank, and a gasket that can prevent permeation of gasoline from a fuel tank more effectively has been desired.

The present invention has been proposed taking into consideration the above-mentioned circumstances. An object of the present invention is to provide a gasket for an automobile fuel tank that is attached to a connection part in which a fuel supply pipe is connected to an automobile fuel tank, and can suppress permeation of gasoline from a fuel tank more effectively.

### Means for Solving the Problems

The gasket for an automobile fuel tank of the present invention is a gasket for an automobile fuel tank that is attached to a connection part in which a fuel supply pipe is connected to an automobile fuel tank and serves to seal the connection part,

wherein a cross-sectionally rectangular annular member made of polytetrafluoroethylene is arranged in close contact with an O-ring made of nitrile-butadiene rubber along an inner periphery or an outer periphery of the O-ring; and

a thickness of the O-ring is larger than a thickness of the annular member and the O-ring protrudes in the thickness direction relative to upper and lower surfaces in the thickness direction of the annular member.

### Advantageous Effects of the Invention

The gasket for an automobile fuel tank according to the present invention can suppress permeation of gasoline from a fuel tank more effectively by attaching the gasket to a connection part in which a fuel supply pipe is connected to the automobile fuel tank.

### BRIEF DESCRIPTION OF THE DRAWINGS

FIG. 1 is an explanatory view showing an outline of the gasket for an automobile fuel tank according to the embodiment of the present invention, in which (a) is a plan view and (b) is an end elevation view showing the cross section taken along the line A-A in (a); and

FIG. 2 is an enlarged cross-sectional view for explaining the working conditions of the gasket for an automobile fuel tank according to the embodiment of the present invention.

### MODE FOR CARRYING OUT THE INVENTION

Hereinbelow, an explanation will be made with reference to the drawings on an embodiment of the gasket for an automobile fuel tank according to the present invention.

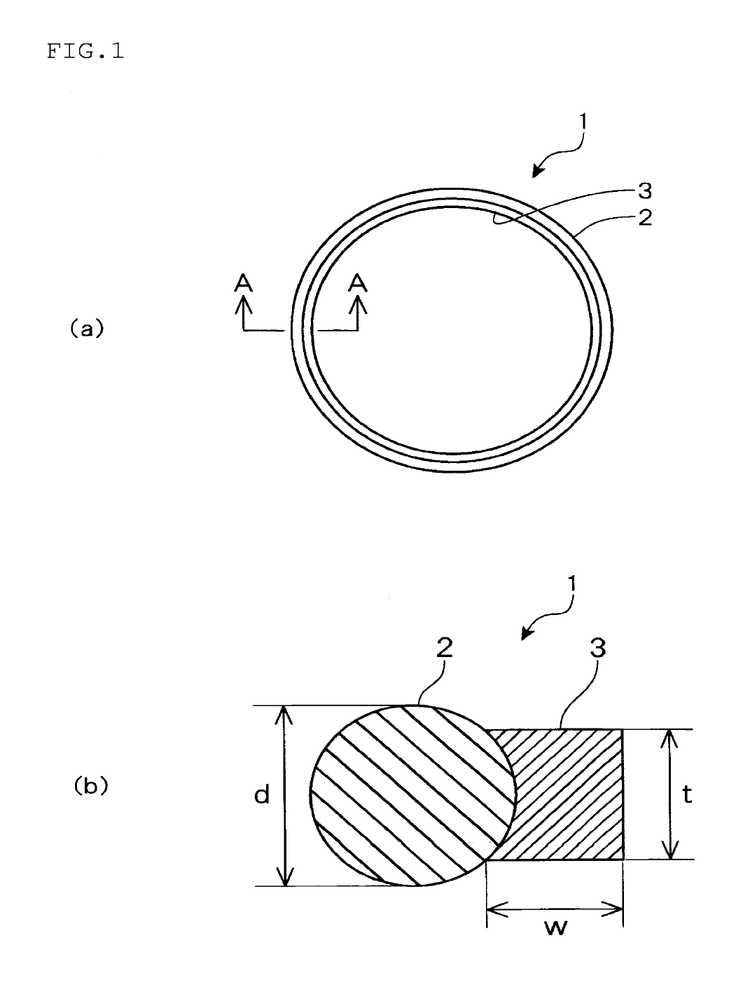

FIG. 1 is an explanatory view showing an outline of the gasket for an automobile fuel tank according to this embodiment, in which (a) is a plan view and (b) is an end elevation view showing the cross section taken along the line A-A in (a).

In this embodiment, a gasket 1 is provided with an O-ring 2 made of NBR (nitrile-butadiene rubber) and a cross-sectionally rectangular annular member 3 made of PTFE (polytetrafluoroethylene). As shown in FIG. 1, the annular member 3 is arranged in close contact with the inner periphery of the O-ring 2.

In the shown example, in the annular member 3, a surface being in close contact with the O-ring 2 is curved along the side surface of the O-ring 2. Due to such a configuration, adhesiveness between the O-ring 2 and the annular member 3 is enhanced. Such sectional shape of the annular member 3 is included in the term “cross-sectionally rectangular”.

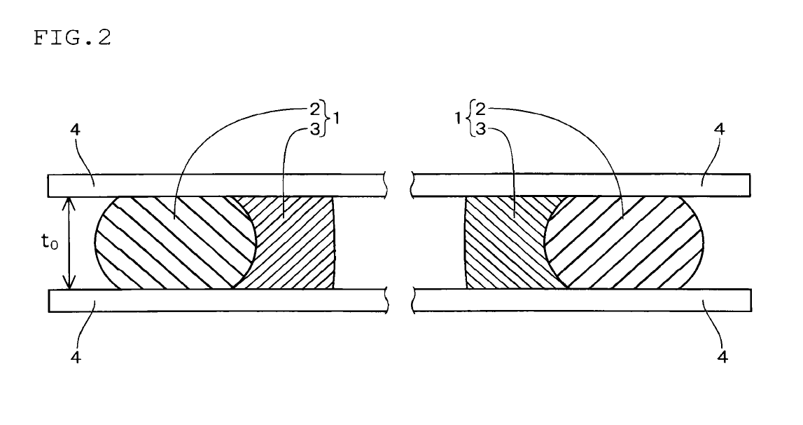

Such a gasket 1 is attached to a connection part in which a fuel supply pipe is connected to an automobile fuel tank (not shown), and seals the connection part. At this time, as shown in FIG. 2, the gasket 1 is tightened by a pair of flanges 4 provided in the connection part.

Leakage of gasoline from a fuel tank is classified into contact surface leakage and permeation. Contact surface leakage means that gasoline vaporized in the fuel tank leaks along a contact surface between the gasket 1 and the flange 4. Permeation means that gasoline vaporized in the fuel tank leaks by permeating the gasket 1 itself. In this embodiment, the annular member 3 is made by using, as a raw material, PTFE having excellent non-permeability for gasoline, and is arranged in close contact with the inner periphery of the O-ring 2, whereby permeation of gasoline is suppressed.

Further, in this embodiment, the O-ring 2 is made by using, as a raw material, NBR that is an elastic material, and the O-ring 2 is protruded in the thickness direction relative to the upper and lower surfaces in the thickness direction of the annular member 3 by allowing the thickness of the O-ring 2 to be larger than the thickness of the annular member 3.

Due to such a configuration, when the gasket 1 is tightened by the flange 4, the O-ring 2 is compressed and is brought into close contact with the flange 4. As a result, contact surface leakage of gasoline that cannot be prevented sufficiently only by the annular member 3 is prevented.

That is, by designing the gasket 1 such that the compression ratio of the annular member 3 becomes a prescribed value when the gasket 1 is tightened by the flange 4, the upper and lower surfaces in the thickness direction of the annular member 3 are brought into close contact with the flange, whereby contact surface leakage can be prevented by the annular member 3. Nevertheless, PTFE has properties that creeping occurs with an increase in temperature. Therefore, it becomes difficult to prevent contact surface leakage of gasoline sufficiently only by the annular member 3 due to environmental changes with the passage of time or the like. By allowing the O-ring 2 to be in close contact with the flange 4 with a prescribed compression ratio, contact surface leakage of gasoline that cannot be prevented sufficiently only by the annular member 3 can be prevented more effectively.

Taking the thickness of the O-ring 2 as “d” and the thickness of the annular member 3 as “t”, respectively, the gasket 1 is tightened by means of a pair of flanges 4. When sealing the connection part between the fuel tank and the pipe, if the distance between the flanges 4 is t₀, the compression ratio of the O-ring 2 is ((d−t₀)/d)×100 (%) and the compression ratio of the annular member 3 is ((t−t₀)/t)×100 (%).

As mentioned above, in the gasket 1 of this embodiment, the annular member 3 plays a role to suppress permeation and contact surface leakage of gasoline that cannot be prevented sufficiently only by the annular member 3 is suppressed by the O-ring 2, whereby permeation of gasoline from an automobile fuel tank can be prevented more effectively.

The present invention was explained above with reference to preferred embodiments. However, the present invention is not limited to the above-mentioned embodiment and it is needless to say that various modifications are possible within the scope of the present invention.

For example, in the above-mentioned embodiment, an explanation was made taking as an example a gasket for sealing plane surfaces. The present invention can be applied to a gasket for sealing cylindrical surfaces and various other gaskets.

Moreover, in the above-mentioned embodiment, an explanation was made taking as an example a gasket in which the annular member is arranged in close contact with the inner periphery of the O-ring. The gasket of the present invention may have a configuration in which the annular member is arranged in close contact with the outer periphery of the O-ring, according to need.

The documents described in this specification and the Japanese application specification claiming priority under the Paris Convention are incorporated herein by reference in its entirety.

### EXPLANATION OF REFERENTIAL NUMERALS

1. Gasket
2. O-ring
3. Annular member

1. A gasket for an automobile fuel tank that is attached to a connection part in which a fuel supply pipe is connected to an automobile fuel tank and seals the connection part,
wherein a cross-sectionally rectangular annular member made of polytetrafluoroethylene is arranged in close contact with an O-ring made of nitrile-butadiene rubber along an inner periphery or an outer periphery of the O-ring; and
a thickness of the O-ring is larger than a thickness of the annular member and the O-ring protrudes in the thickness direction relative to upper and lower surfaces in the thickness direction of the annual member.

2. The gasket for an automobile fuel tank according to claim 1, wherein a surface of the annular member contacts closely with the O-ring is curved along a side surface of the O-ring.
